(19) United States
(12) Patent Application Publication
(10) Pub. No.: US 2019/0042487 A1
(43) Pub. Date: Feb. 7, 2019

(54) HIGH-BANDWIDTH, LOW-LATENCY, ISOCHORONOUS FABRIC FOR GRAPHICS ACCELERATOR

(71) Applicant: Intel Corporation, Santa Clara, CA (US)

(72) Inventors: Lakshminarayana Pappu, Folsom, CA (US); Aravindh Anantaraman, Santa Clara, CA (US); Ritu Gupta, Santa Clara, CA (US); Robert Adler, Santa Clara, CA (US)

(21) Appl. No.: 15/842,562

(22) Filed: Dec. 14, 2017

(51) Int. Cl. G06F 13/16; G06F 13/42; G06F 12/14

(52) U.S. Cl. CPC G06F 13/1615; G06F 2212/1052; G06F 12/14; G06F 13/4239

(57) ABSTRACT

Techniques are provided for low-latency, high bandwidth graphics accelerator die and memory system. In an example, a graphics accelerator die can include a plurality of memory blocks for storing graphic information, a display engine configured to request and receive the graphic information from the plurality of memory blocks for transfer to a display, a graphics engine configured to generate and transfer the graphic information to the plurality of memory blocks, and a high-bandwidth, low-latency isochronous fabric configured to arbitrate the transfer and reception of the graphic information.

### TECHNICAL FIELD

This document pertains generally, but not by way of limitation, to memory circuits, and more particularly to isochronous techniques for graphics memory circuits.

### BACKGROUND

In a processing system, certain devices have expected performance standards. These performance standards can be satisfied by the retrieval of requested data from memory in a sufficient amount of time so as not to interrupt the operation of the requesting devices. Graphic accelerators are a type if device where failure to maintain a performance standard via retrieval of graphics data from memory can interrupt visual display continuity for a user and detrimentally impact the user experience.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates generally a system including an example isochronous fabric.

FIG. 2 illustrates generally a detail diagram of an example high-bandwidth isochronous agent.

FIG. 3 illustrates generally a timeline drawing of an example isochronous request interaction between a display engine, the isochronous fabric and the graphics memory circuit.

FIG. 4 illustrates a block diagram of an example machine upon which any one or more of the techniques (e.g., methodologies) discussed herein may perform.

FIG. 5 illustrates a system level diagram, depicting an example of an electronic device (e.g., system) including an example graphical accelerator.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The present inventors have recognized an isochronous mesh architecture for multiple pipeline graphic accelerators, however, the isochronous mesh may be used for other processing applications where timely data retrieval can improve the operation of the processing system or can provide an enhanced user experience. Such systems can include, but are not limited to, navigation, tracking, simulation, gaming, forecasting, analysis, or combinations thereof.

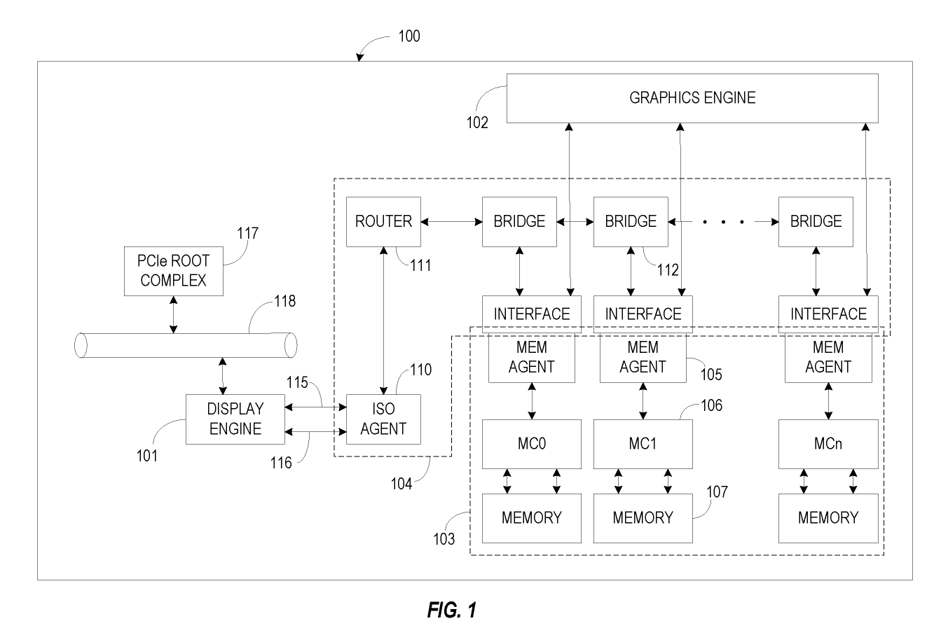

FIG. 1 illustrates generally a system 100 including an example isochronous fabric 104. In certain examples, the system 100 is a graphic accelerator die. The system 100 can include a display engine 101, a graphics engine 102, a graphics memory circuit 103, and an isochronous fabric 104. The graphics engine 102 can, among other things, respond to various inputs, conduct 2-dimensional or 3-dimensional rendering, and provide graphics information to the graphics memory circuit 103. The display engine 101 can receive the graphics information from the graphics memory circuit 103 via the isochronous fabric 104 and can convert the graphics information to display information or display signals for output to one or more physical displays or monitors (not shown).

The graphics memory circuit 103 can include one or more blocks or columns of memory. Each block can include a memory agent circuit 105, a memory controller 106, and memory circuits 107. In certain examples, the graphics memory circuit 103 can be a high-bandwidth memory (HBM) system. In some examples, the memory controller 106 for each block of memory can provide more than one channel for interfacing or transferring data with the corresponding memory circuits 107. In certain examples, a multiplexer (not shown) of the memory controller 106, or of the block of memory, can manage the flow of information of the multiple channels of the memory controller 106 and a first communication channel of the memory agent circuit 105. In certain examples, the first communication channel of the memory agent circuit 105 can be as wide as the combined width of the multiple channels of the memory controller 106. In the illustrated example, the each of two channels of the memory controller 106 are 16 bits wide and operate at 2 gigabytes/sec (Gb/sec). The first communication channel of the memory agent circuit 105 can be 32 bits wide and can operate at 2 Gb/sec. In some examples, the graphics memory circuit 103 can include 2N blocks of memory or more, where N is an integer greater than 2, without departing from the scope of the present subject matter.

The isochronous fabric 104 can provide very high speed graphic information retrieval for the display engine 101. In certain examples, the isochronous fabric 104 can retrieve graphics information from the graphics memory circuit 103 at 128 gigabytes per sec or higher bandwidth when requested for example, via a read request from the display engine 101. In some examples, the isochronous fabric 104 can retrieve graphics information from the graphics memory circuit 103 can provide uninterrupted blocks of data at 128 gigabytes per second bandwidth when requested. Providing the display engine 101 with access to graphics information at such high speed and in an interrupted fashion, can allow the graphics accelerator die or system 100 to provide smooth, uninterrupted, high-resolution video playback compared with conventional graphic accelerator capabilities. The isochronous fabric 104 can include a high-bandwidth, isochronous agent 110, an isochronous router system including an isochronous router 111 and an isochronous bridge circuit 112 for each of block or column of memory, and an isochronous interface 113 for each memory agent circuit 105 of each memory block.

The isochronous router system can decode aligned address requests received from the high-bandwidth, isochronous agent 110 and can route each request to one of the multiple memory blocks of the graphics memory circuit 103. In certain examples, routing functions can be based on memory address hashing algorithms configured for the graphics memory circuit 103. Once each request is routed to a memory block, an isochronous interface 113 can prioritize the request for a corresponding memory agent circuit 105. The memory agent circuit 105 can receive requests for memory activity from either the data engine 101 or the graphics engine 102 and can relay the requests to the memory controller 106 and data to the memory agent circuit 105. Some read requests from the display engine 101 can be isochronous read requests. Isochronous requests are time critical. In response to an isochronous read request, the isochronous interface 113 can work in cooperation with the memory agent circuit 105, in an isochronous transfer mode, to relay the request to the memory controller 106, to give the request top priority, and to not allow interruption of the retrieval or transfer of the graphic information associated with the request, for example, by a write request from the graphics engine 102.

In certain examples, the high-bandwidth isochronous agent 110 can receive graphic information requests from one or more pipelines 115, 116 of the display engine 101, create tracking entries for the requests, convert the requests to memory requests, receive the graphics information associated with each memory request, assemble the graphics information associated each graphics information request using the tracking entries, and stream the assembled graphics data to the proper pipeline 115, 116 of the display engine 101. In certain examples, the high-bandwidth, isochronous agent 110 can receive and communicate isochronous graphics information with a 128 Gbyte/sec bandwidth.

In certain examples, the system 100 can interface with a host (not shown). In some examples, the system 100 can include a Peripheral Component Interconnect Express (PCIe) root complex 117 to interface with the host. The PCIe root complex 117 can communicate with other components of the system 100 via a primary scalable fabric (PSF) 118. Such other components can include, but are not limited to, the display engine 101, the graphics engine 102, or combinations thereof. In certain examples, the display engine 101 can include one of more ports (not shown) to provide display information to a physical display or monitor. In some examples, the one or more ports can include support for high-resolution, high dynamic range, dual 8K60 workloads.

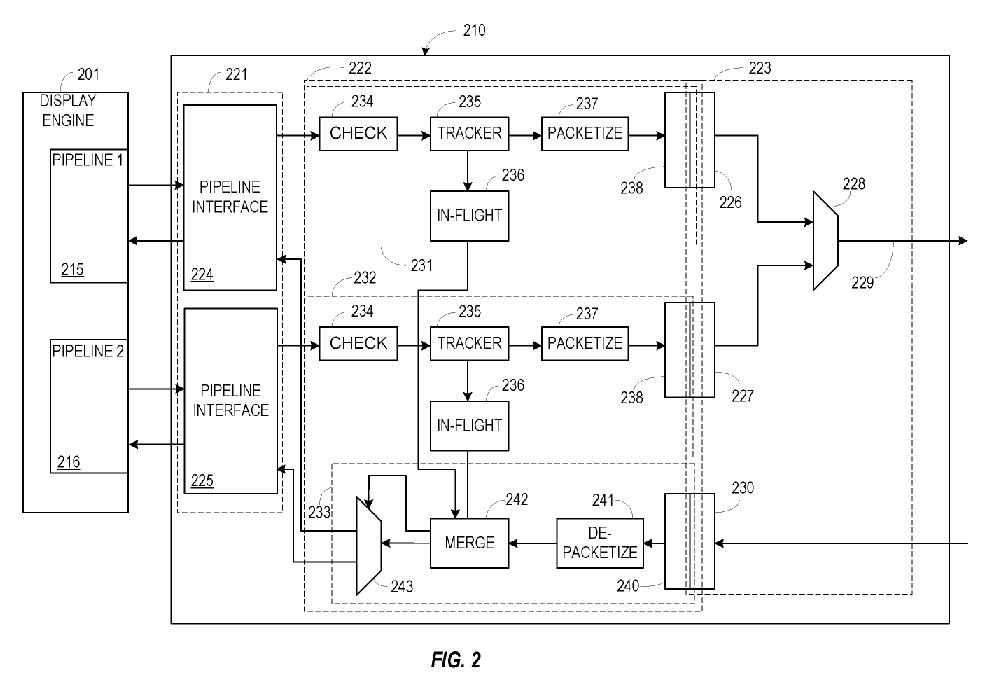

FIG. 2 illustrates generally a detail diagram of an example high-bandwidth isochronous agent 210. The high bandwidth isochronous agent 210 can include a display engine interface circuit 221, a processing circuit 222, and a router interface circuit 223. In certain examples, the display engine interface circuit 221 can include one or more display engine pipeline transceiver circuits 224, 225. Each display engine pipeline transceiver circuit 224, 225 can receive requests for graphic information from the display engine 201 and can provide requested graphic information or status information to the display engine 201. In certain examples, each pipeline 215, 216 of the display engine 201 can operate independently.

The router interface circuit 223 can provide memory requests to the isochronous router system (FIG. 1; 111, 112, 113) and receive graphical data from the isochronous router system. In certain examples, the router interface circuit 223 can include a request stack 226, 227 to buffer memory requests from each pipeline and a multiplexer 228 to route memory requests from the multiple pipelines 215, 216 to the single router processing path 229. In certain examples, the request stack can be a first-in, first-out (FIFO) stack structure. In certain examples, the router interface circuit 223 can receive graphics information from the isochronous router system to a reception stack 230 for delivery to the processing circuit 222. In certain examples, the reception stack 230 can be a FIFO stack structure.

The processing circuit 222 of the high-bandwidth isochronous agent 210 can include a request processing path 231, 232 for each display engine pipeline 215, 216, and a data processing path 233 for delivery of retrieved graphics information to the appropriate display engine pipeline 215, 216. Each request processing path 231, 232 can include an optional security check circuit 234, an optional read tracker circuit 235, an in-flight array 236, a memory packetizer 237, and a memory request stack 238. The optional security check circuit 234 can evaluate memory locations of the request received from the display engine 201 against protected areas of memory. If the request fails to provide valid credentials to access protected areas of memory, the security check circuit 234 can cease to pass the request further through the request processing path 231, 232. In some examples, if the request fails to provide valid credentials to access protected areas of memory, the security check circuit 234 can provide an indication of the request failure to the display engine 201.

In certain examples, each request can request a finite chuck of graphical information, for example, but not by way of limitation, a 64 byte chuck of graphical information. The requests can be issued by the display engine 201 without any particular time, or sequential order, relationship to a time-wise adjacent request. The read tracker circuit 235 can evaluate and analyze incoming requests for a time or sequential order relationship and can provide the request with an indication of the order relationship. Such an indication can be used to prioritize requests, schedule requests, assemble retrieved graphic information, or combinations thereof. In certain examples, the indications of order relationship, as well as parameters of the request, can be stored in an in-flight array circuit 236 and retrieved during the assembly of the graphics information for delivery to the display engine 201.

The memory packetizer 237 can convert the requests from the request protocol to a memory request protocol. The data processing stack 238 can buffer the memory requests for the router interface circuit 223.

The data processing path 233 of the processing circuit of the high-bandwidth isochronous agent 210 can include an input stack 240, a de-packetizer circuit 241, a merge circuit 242 and a multiplexer 243. The input stack 240 can buffer the incoming graphic information retrieved from the graphics memory circuit (FIG. 1; 103). The de-packetizer circuit 241 can convert the packets of retrieved data from the format used by the graphics memory circuit to a format compatible with assembling the graphics information for delivery to the display engine 201. The merge circuit 242 can use information received with packets of the incoming graphic information and information retrieved from the in-flight array 236 to assemble blocks of graphics information associated with a corresponding request. In certain examples, the merge circuit 242 can assemble the most time-critical graphics information before assembling other graphics information. In addition, the merge circuit 242 can control the multiplexer 243 to provide the assembled graphics information to the appropriate pipeline 215, 216 of the display engine 201. In certain examples, the merge circuit 242 can use information stored in the in-flight array 236 to determine the appropriate display engine pipeline 215, 216, or the merge circuit 242 can use information received with the graphics information to determine the appropriate display engine pipeline 215, 216.

In certain examples, the router interface circuit 223 of the high-bandwidth isochronous agent 210 can have a different clock or clock signal than the clock or clock signal of the display engine interface circuit 221 and the processing circuit 222 of the high-bandwidth isochronous agent 210. In some examples, the frequency of the clock signal of the router interface circuit 223 can operate at a higher frequency than the clock signal of the display engine interface circuit 221 and the processing circuit 222. In some examples, the frequency of the clock signal of the router interface circuit 223 can be twice the frequency of the clock signal of the display engine interface circuit 221 and the processing circuit 222. For example, the display may be able to receive graphics information from the isochronous agent with a bandwidth of up to 85 Gb/sec and the isochronous fabric is capable of providing graphics information with a bandwidth of up to 128 Gb/sec.

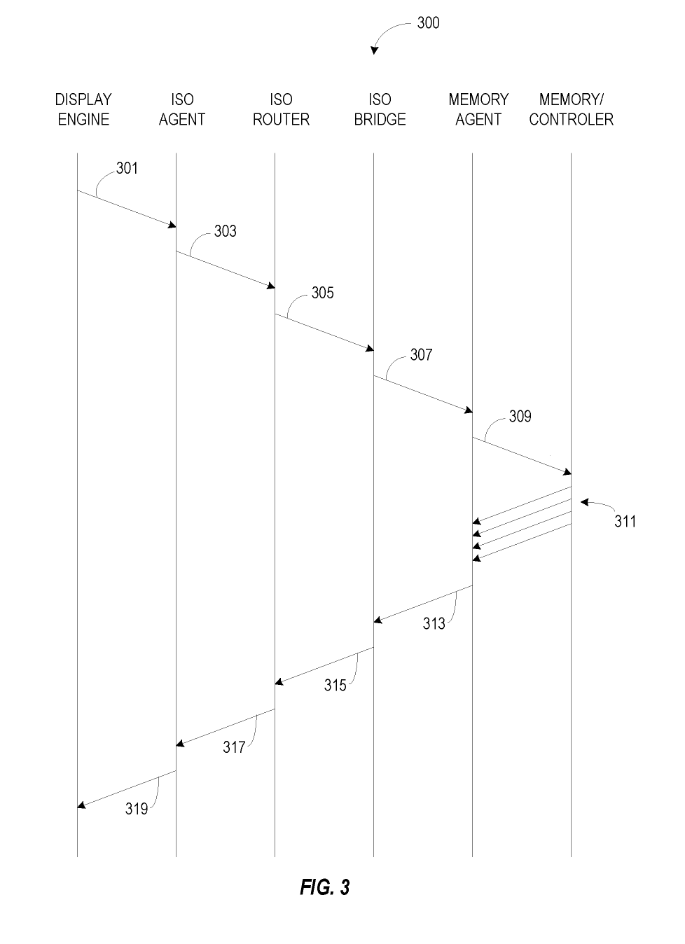

FIG. 3 illustrates generally a timeline drawing of an example isochronous request interaction between a display engine, the isochronous fabric and the graphics memory circuit. At 301, a request can be received at a high-bandwidth, isochronous agent (ISO AGENT). The high-bandwidth, isochronous agent can receive requests simultaneously from more than one display engine pipeline. The high-bandwidth, isochronous agent can process each request and can transfer memory requests to an isochronous routing system. At 303, the memory requests can be received at an isochronous router of the routing system and, at 305, can further be passed to one of a number of isochronous bridge circuits. Each isochronous bridge circuit can be coupled to a corresponding block or column of memory and can determine whether the memory request seeks graphic information stored within the corresponding memory block. At 307, upon determining the memory request seeks data within the associated memory block, the memory request can be passed to and received at a memory agent circuit of the associated memory block. The memory agent circuit can include an isochronous interface that can receive each memory request, and if the request is time-critical, or marked as an isochronous request, can prevent the memory agent circuit from interrupting the memory controller of the block of memory until the request has been fulfilled.

At 309, the memory request can be passed to the memory controller. At 311, the graphic information requested can be retrieved from the memory circuits and passed from the memory controller to the memory agent circuit. In certain examples, the graphic information can be retrieved in chunks from the memory circuits and assembled into a continuous block of graphic data at the memory agent circuit. At 313, the continuous block of graphic data can be passed from the isochronous agent to the isochronous bridge circuit. At 315, the continuous block of graphic information can be passed from the isochronous bridge circuit to the isochronous router. At 317, the continuous block of graphic information can be passed from the isochronous router to the high-bandwidth, isochronous agent. At 319, as discussed above, the continuous block of graphic information can be converted from a memory protocol to a display engine protocol, can be assembled with proper identifying information about the corresponding display engine request that initiated the retrieval of the graphic information, and can be routed to the proper display engine pipeline. In certain examples, the isochronous fabric including the high-bandwidth, isochronous agent, the isochronous routing system, and the isochronous interface to the memory agent circuits can retrieve graphic information with a bandwidth of 128 Gbytes/sec. In certain examples, each memory request can be fulfilled by providing 64 bytes of graphical information at 2 GHz. In some examples, the memory circuits and memory controller can use multiple channels to provide 4 chucks of 16 bytes each at a bandwidth of 2 GHz.

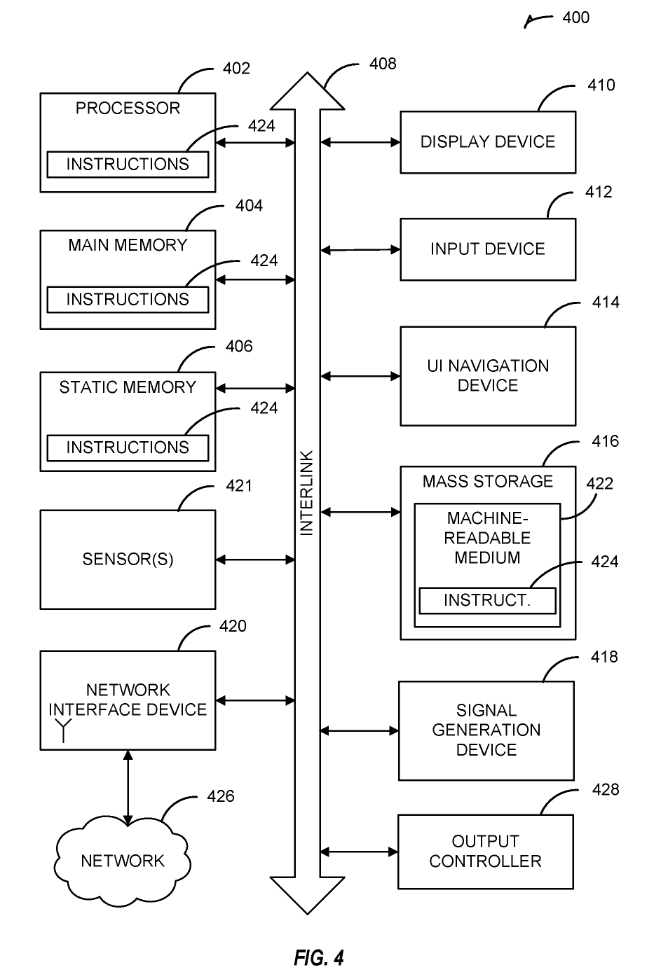

FIG. 4 illustrates a block diagram of an example machine 400 upon which any one or more of the techniques (e.g., methodologies) discussed herein may perform. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (or other distributed) network environment. As used herein, peer-to-peer refers to a data link directly between two devices (e.g., it is not a hub-and spoke topology). Accordingly, peer-to-peer networking is networking to a set of machines using peer-to-peer data links. The machine 400 may be a single-board computer, an integrated circuit package, a system-on-a-chip (SOC), a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry at a different time.

Machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410 that can include or receive display information from a graphic accelerator die as described above, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, a signal generation device 418 (e.g., a speaker), a network interface device 420, and one or more sensors 421, such as a global positioning system (GPS) sensor, compass, accelerometer, or other sensor. The machine 400 may include an output controller 428, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. In an example, a massed machine readable medium comprises a machine readable medium with a plurality of particles having invariant (e.g., rest) mass. Accordingly, massed machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 400, and includes digital or analog communications signals or other intangible medium to facilitate communication of such software.

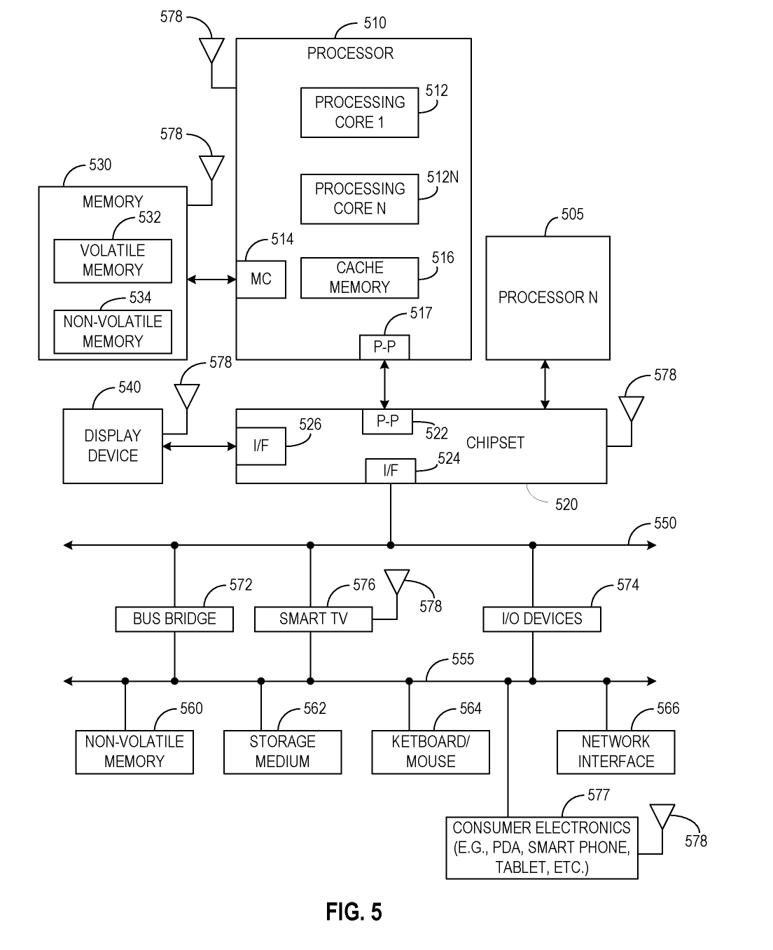

FIG. 5 illustrates a system level diagram, depicting an example of an electronic device (e.g., system) including integrated circuits with a graphic accelerator die as described in the present disclosure. FIG. 5 is included to show an example of a higher level device application that can use an graphics accelerator die. In one embodiment, system 500 includes, but is not limited to, a desktop computer, a laptop computer, a netbook, a tablet, a notebook computer, a personal digital assistant (PDA), a server, a workstation, a cellular telephone, a mobile computing device, a smart phone, an Internet appliance or any other type of computing device. In some embodiments, system 500 is a system on a chip (SOC) system.

In one embodiment, processor 510 has one or more processor cores 512 and 512N, where 512N represents the Nth processor core inside processor 510 where N is a positive integer. In one embodiment, system 500 includes multiple processors including 510 and 505, where processor 505 has logic similar or identical to the logic of processor 510. In some embodiments, processing core 512 includes, but is not limited to, pre-fetch logic to fetch instructions, decode logic to decode the instructions, execution logic to execute instructions and the like. In some embodiments, processor 510 has a cache memory 516 to cache instructions and/or data for system 500. Cache memory 516 may be organized into a hierarchal structure including one or more levels of cache memory.

In some embodiments, processor 510 includes a memory controller 514, which is operable to perform functions that enable the processor 510 to access and communicate with memory 530 that includes a volatile memory 532 and/or a non-volatile memory 534. In some embodiments, processor 510 is coupled with memory 530 and chipset 520. Processor 510 may also be coupled to a wireless antenna 578 to communicate with any device configured to transmit and/or receive wireless signals. In one embodiment, an interface for wireless antenna 578 operates in accordance with, but is not limited to, the IEEE 802.11 standard and its related family, Home Plug AV (HPAV), Ultra Wide Band (UWB), Bluetooth, WiMax, or any form of wireless communication protocol.

In some embodiments, volatile memory 532 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. Non-volatile memory 534 includes, but is not limited to, flash memory, phase change memory (PCM), read-only memory (ROM), electrically erasable programmable read-only memory (EEPROM), or any other type of non-volatile memory device.

Memory 530 stores information and instructions to be executed by processor 510. In one embodiment, memory 530 may also store temporary variables or other intermediate information while processor 510 is executing instructions. In the illustrated embodiment, chipset 520 connects with processor 510 via Point-to-Point (PtP or P-P) interfaces 517 and 522. Chipset 520 enables processor 510 to connect to other elements in system 500. In some embodiments of the example system, interfaces 517 and 522 operate in accordance with a PtP communication protocol such as the Intel® QuickPath Interconnect (QPI) or the like. In other embodiments, a different interconnect may be used.

In some embodiments, chipset 520 is operable to communicate with processor 510, 505N, display device 540, and other devices, including a bus bridge 572, a smart TV 576, I/O devices 574, nonvolatile memory 560, a storage medium (such as one or more mass storage devices) [this is the term in Fig—alternative to revise Fig. to “mass storage device(s)”—as used in para. 8] 562, a keyboard/mouse 564, a network interface 566, and various forms of consumer electronics 577 (such as a PDA, smart phone, tablet etc.), etc. In one embodiment, chipset 520 couples with these devices through an interface 524. Chipset 520 may also be coupled to a wireless antenna 578 to communicate with any device configured to transmit and/or receive wireless signals.

Chipset 520 connects to display device 540 via interface 526. IN certain examples, chipset 52 can include a graphics accelerator die as discussed above. Display 540 may be, for example, a liquid crystal display (LCD), a plasma display, cathode ray tube (CRT) display, dual high resolution 8k60 monitors, or any other form of visual display device. In some embodiments of the example system, processor 510 and chipset 520 are merged into a single SOC. In addition, chipset 520 connects to one or more buses 550 and 555 that interconnect various system elements, such as I/O devices 574, nonvolatile memory 560, storage medium 562, a keyboard/mouse 564, and network interface 566. Buses 550 and 555 may be interconnected together via a bus bridge 572.

In one embodiment, mass storage device 562 includes, but is not limited to, a solid state drive, a hard disk drive, a universal serial bus flash memory drive, or any other form of computer data storage medium. In one embodiment, network interface 566 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra Wide Band (UWB), Bluetooth, WiMax, or any form of wireless communication protocol.

While the modules shown in FIG. 5 are depicted as separate blocks within the system 500, the functions performed by some of these blocks may be integrated within a single semiconductor circuit or may be implemented using two or more separate integrated circuits. For example, although cache memory 516 is depicted as a separate block within processor 510, cache memory 516 (or selected aspects of 516) can be incorporated into processor core 512.

### Additional Notes

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment, and it is contemplated that such embodiments can be combined with each other in various combinations or permutations. The scope of the invention should be determined with reference to the appended claims, along with the full scope of equivalents to which such claims are legally entitled.

What is claimed is:

1. A graphics memory circuit comprising:
first memory circuits;
a first memory controller configured to receive read requests and write requests, to retrieve data from the first memory circuit in response to the read requests, and to transfer data to the first memory circuits in response to the write requests;
a first memory agent circuit configured to relay the read requests from a first isochronous bridge circuit coupled to a display engine and the write requests received from a graphics engine, wherein the read requests can include an isochronous read request; and
an first isochronous interface coupled to the memory agent circuit, the isochronous interface configured to enable an isochronous transfer mode in response to the isochronous read request, the isochronous transfer mode configured to transfer graphic information requested by the isochronous read request at a priority higher than other read requests and the write requests received at the first memory agent circuit.

2. The graphics memory circuit of claim 1, wherein the first memory circuits and the first memory controller form a high-bandwidth memory (HBM) structure.

3. The graphics memory circuit of claim 1, wherein the first memory circuits are coupled to the first memory controller with multiple channels.

4. The graphics memory circuit of claim 3, wherein a combined access speed of the multiple channels has a bandwidth of up to 128 gigabytes per second.

5. The graphics memory circuit of claim 1, wherein the first isochronous interface is configured to allow a transfer of the graphic information from the first memory circuits to the first isochronous bridge without interruption due one of the write requests from the graphics engine.

6. The graphics memory circuit of claim 1, including the first isochronous bridge, the first isochronous bridge configured to receive the read requests and to execute a hashing algorithm routine to determine whether to pass the read request to the first memory agent.

7. The graphics memory circuit of claim 5, including a plurality of memory blocks coupled to the display engine and to the graphics engine; and
wherein a first memory block of the plurality of memory blocks includes the first memory circuits, the first memory controller, the first memory agent, the first isochronous interface, and the first isochronous bridge.

8. The graphics memory circuit of claim 7, wherein the plurality of memory blocks include 2^{N} memory blocks; and
wherein N is an integer number greater than 2.

9. A method comprising:
receiving a plurality of high priority requests for graphics information from a first display engine pipeline and a second display engine pipeline;
issuing memory read requests to a isochronous router in response to one of the plurality of high priority requests;
receiving the graphics information in one or more packets from the isochronous router;
de-packetizing the graphics information from the one or more packets
merging the graphics information associated with a corresponding high priority request of the plurality of high priority requests; and
transferring the graphics information to one of the first and second pipelines.

10. The method of claim 9, including identifying and storing an indication of each high priority request of the plurality of high priority requests.

11. The method of claim 10, wherein the merging the graphics information associated with a corresponding high priority request of the plurality of high priority request includes identifying the corresponding high priority request using one or more of the indication.

12. The method of claim 9, wherein issuing the memory read requests includes packetizing the memory read requests.

13. The method of claim 9, wherein receiving the graphics information includes receiving the graphics information at a rate of up to 128 gigabytes per second.

14. The method of claim 9, wherein transferring the graphics information includes transferring the graphics information to a pipeline of the first and second pipelines associated with the corresponding high priority request.

15. A graphics accelerator die comprising:
a plurality of memory blocks for storing graphic information;
a display engine configured to request and receive the graphic information from the plurality of memory blocks for transfer to a display;
a graphics engine configured to generate and transfer the graphic information to the plurality of memory blocks; and
a high-bandwidth, low-latency isochronous fabric configured to arbitrate the transfer and reception of the graphic information; and
wherein, in a first mode, the graphic information can be received at the display engine at 85 gigabytes per sec (GBytes/sec) or faster.

16. The graphics accelerator die of claim 15, wherein the graphic information can be received at the display engine at 128 gigabytes per sec (GBytes/sec) or faster.

17. The graphics accelerator die of claim 15 including a Peripheral Component Interconnect Express (PCIe) root complex configured to couple the display engine to a host computer.

18. The graphics accelerator die of claim 15, wherein the display engine is configured to provide display signaling for dual 8K monitors.

19. The graphics accelerator die of claim 15, wherein each memory block of the plurality of memory blocks includes:
an isochronous bridge coupled to the display engine;
an high-bandwidth memory (HBM) circuit including a memory controller, the memory controller configured to receive read requests and write requests, to retrieve information from the memory circuits of the HBM circuit in response to the read requests, and to transfer information to the memory circuits in response to the write requests;
a memory agent circuit configured to relay the read requests from the isochronous bridge, and the write requests received from a graphics engine, to the HBM circuit, wherein the read requests can include an isochronous read request; and
an isochronous interface coupled between the memory agent and the isochronous bridge, the isochronous interface configured to enable an isochronous transfer mode in response to the isochronous read request, the isochronous transfer mode configured to transfer graphic information requested by the isochronous read request at a priority higher than other read requests and higher than the write requests.

20. The graphics accelerator die of claim 15, wherein the high-bandwidth, low-latency isochronous fabric includes:
an isochronous agent configured to receive read requests from one or more pipelines of the display engine; and
an isochronous router to relay the read requests to the plurality of memory blocks; and
wherein the isochronous agent is further configured to screen the read requests to prevent unauthorized access to secure memory, to store tracking information about each read request into an in-flight array, to merge the retrieved graphic information for delivery to the display engine using the track information, and to provide the graphic information retrieved from the plurality of memory blocks at a pipeline, of the one or more pipelines, corresponding to a respective read request using the track information.
